(19) United States
(12) Patent Application Publication
(10) Pub. No.: US 2006/0186887 A1
(43) Pub. Date: Aug. 24, 2006

(54) Method for identifying subsurface features from marine transient controlled source electromagnetic surveys

(76) Inventors: Kurt M. Strack, Houston, TX (US); Leon A. Thomsen, Houston, TX (US); Charles H. Stoyer, Golden, CO (US)

Correspondence Address: RICHARD A. FAGIN, P.O. BOX 1247, RICHMOND, TX, 77406-1247, US

(21) Appl. No.: 11/064,063

(22) Filed: Feb. 22, 2005

(51) Int. Cl. G01V 3/10

(52) U.S. Cl. 324/336

(57) ABSTRACT

A method for identifying features in the Earth's subsurface below a body of water using transient controlled source electromagnetic measurements includes acquiring a plurality of transient controlled source electromagnetic measurements. Each measurement represents a different value of an acquisition parameter. Each measurement is indexed with respect to a time at which an electric measuring current source is switched. The plurality of measurements is processed in a seismic trace display format, in which each trace corresponds to the measurement acquired for a value of the acquisition parameter. A subsurface feature is identified from the processed measurements.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF INVENTION

1. Field of the Invention

The invention relates generally to the field of controlled source marine electromagnetic surveying. More specifically, the invention relates to methods for processing and display of data from marine transient electromagnetic surveys such that subsurface features may be identified.

2. Background Art

Marine electromagnetic surveying includes “controlled source” surveying.

Controlled source surveying includes imparting an electric current or a magnetic field into the sea floor, and measuring voltages and/or magnetic fields induced in electrodes, antennas and/or magnetometers disposed on the sea floor. The voltages and/or magnetic fields are induced in response to the electric current and/or magnetic field imparted into the Earth's subsurface through the sea floor.

Controlled source surveying known in the art typically includes imparting alternating electric current into the sea floor. The alternating current has one or more selected frequencies. Such surveying is known as frequency domain controlled source electromagnetic (f-CSEM) surveying. f-CSEM surveying techniques are described, for example, in Sinha, M. C. Patel, P. D., Unsworth, M. J., Owen, T. R. E., and MacCormack, M. G. R., 1990, An active source electromagnetic sounding system for marine use, Marine Geophysical Research, 12, 29-68. Other publications which describe the physics of and the interpretation of electromagnetic subsurface surveying include: Edwards, R. N., Law, L. K., Wolfgram, P. A., Nobes, D. C., Bone, M. N., Trigg, D. F., and DeLaurier, J. M., 1985, First results of the MOSES experiment: Sea sediment conductivity and thickness determination, Bute Inlet, British Columbia, by magnetometric offshore electrical sounding: Geophysics 50, No. 1, 153-160; Edwards, R. N., 1997, On the resource evaluation of marine gas hydrate deposits using the sea-floor transient electric dipole-dipole method: Geophysics, 62, No. 1, 63-74; Chave, A. D., Constable, S. C. and Edwards, R. N., 1991, Electrical exploration methods for the seafloor: Investigation in geophysics No 3, Electromagnetic methods in applied geophysics, vol. 2, application, part B, 931-966; and Cheesman, S. J., Edwards, R. N., and Chave, A. D., 1987, On the theory of sea-floor conductivity mapping using transient electromagnetic systems: Geophysics, 52, No. 2, 204-217.

Following are described several patent publications which describe various aspects of electromagnetic subsurface Earth surveying. U.S. Pat. No. 5,770,945 issued to Constable describes a magnetotelluric (MT) system for sea floor petroleum exploration. The disclosed system includes a first waterproof pressure case containing a processor, AC-coupled magnetic field post-amplifiers and electric field amplifiers, a second waterproof pressure case containing an acoustic navigation/release system, four silver-silver chloride electrodes mounted on booms and at least two magnetic induction coil sensors. These elements are mounted together on a plastic and aluminum frame along with flotation devices and an anchor for deployment to the sea floor. The acoustic navigation/release system serves to locate the measurement system by responding to acoustic “pings” generated by a ship-board unit, and receives a release command which initiates detachment from the anchor so that the buoyant package floats to the surface for recovery. The electrodes used to detect the electric field are configured as grounded dipole antennas. Booms by which the electrodes are mounted onto a frame are positioned in an X-shaped configuration to create two orthogonal dipoles. The two orthogonal dipoles are used to measure the complete vector electric field. The magnetic field sensors are multi-turn, Mu-metal core wire coils which detect magnetic fields within the frequency range typically used for land-based MT surveys. The magnetic field coils are encased in waterproof pressure cases and are connected to the logger package by high pressure waterproof cables. The logger unit includes amplifiers for amplifying the signals received from the various sensors, which signals are then provided to the processor which controls timing, logging, storing and power switching operations. Temporary and mass storage is provided within and/or peripherally to the processor.

U.S. Pat. No. 6,603,313 B1 issued to Srnka discloses a method for surface estimation of reservoir properties, in which location of and average earth resistivities above, below, and horizontally adjacent to subsurface geologic formations are first determined using geological and geophysical data in the vicinity of the subsurface geologic formation. Then dimensions and probing frequency for an electromagnetic source are determined to substantially maximize transmitted vertical and horizontal electric currents at the subsurface geologic formation, using the location and the average earth resistivities. Next, the electromagnetic source is activated at or near surface, approximately centered above the subsurface geologic formation and a plurality of components of electromagnetic response is measured with a receiver array. Geometrical and electrical parameter constraints are determined, using the geological and geophysical data. Finally, the electromagnetic response is processed using the geometrical and electrical parameter constraints to produce inverted vertical and horizontal resistivity depth images. Optionally, the inverted resistivity depth images may be combined with the geological and geophysical data to estimate the reservoir fluid and shaliness properties.

U.S. Pat. No. 6,628,110 B1 issued to Eidesmo et al. discloses a method for determining the nature of a subterranean reservoir whose approximate geometry and location are known. The disclosed method includes: applying a time varying electromagnetic field to the strata containing the reservoir; detecting the electromagnetic wave field response; and analyzing the effects on the characteristics of the detected field that have been caused by the reservoir, thereby determining the content of the reservoir, based on the analysis.

U.S. Pat. No. 6,541,975 B2 issued to Strack discloses a system for generating an image of an Earth formation surrounding a borehole penetrating the formation. Resistivity of the formation is measured using a DC measurement, and conductivity and resistivity of the formations is measured with a time domain signal or AC measurement. Acoustic velocity of the formation is also measured. The DC resistivity measurement, the conductivity measurement made with a time domain electromagnetic signal, the resistivity measurement made with a time domain electromagnetic signal and the acoustic velocity measurements are combined to generate the image of the Earth formation.

International Patent Application Publication No. WO 0157555 A1 discloses a system for detecting a subterranean reservoir or determining the nature of a subterranean reservoir whose position and geometry is known from previous seismic surveys. An n electromagnetic field is applied by a transmitter on the seabed and is detected by antennae also on the seabed. A refracted wave component is sought in the wave field response, to determine the nature of any reservoir present.

International Patent Application Publication No. WO 03048812 A1 discloses an electromagnetic survey method for surveying an area previously identified as potentially containing a subsea hydrocarbon reservoir. The method includes obtaining first and second survey data sets with an electromagnetic source aligned end-on and broadside relative to the same or different receivers. The invention also relates to planning a survey using this method, and to analysis of survey data taken in combination allow the galvanic contribution to the signals collected at the receiver to be contrasted with the inductive effects, and the effects of signal attenuation, which are highly dependent on local properties of the rock formation, overlying water and air at the survey area. This is very important to the success of using electromagnetic surveying for identifying hydrocarbon reserves and distinguishing them from other classes of structure.

U.S. Pat. No. 6,842,006 B1 issued to Conti et al. discloses a sea-floor electromagnetic measurement device for obtaining underwater magnetotelluric (MT) measurements of earth formations. The device includes a central structure with arms pivotally attached thereto. The pivoting arms enable easy deployment and storage of the device. Electrodes and magnetometers are attached to each arm for measuring electric and magnetic fields respectively, the magnetometers being distant from the central structure such that magnetic fields present therein are not sensed. A method for undertaking sea floor measurements includes measuring electric fields at a distance from the structure and measuring magnetic fields at the same location.

U.S. Patent Application Publication No. 2004 232917 relates to a method of mapping subsurface resistivity contrasts by making multichannel transient electromagnetic (MTEM) measurements on or near the Earth's surface using at least one source, receiving means for measuring the system response and at least one receiver for measuring the resultant earth response. All signals from the or each source-receiver pair are processed to recover the corresponding electromagnetic impulse response of the earth and such impulse responses, or any transformation of such impulse responses, are displayed to create a subsurface representation of resistivity contrasts. The system and method enable subsurface fluid deposits to be located and identified and the movement of such fluids to be monitored.

U.S. Pat. No. 5,467,018 issued to Rueter et al. discloses a bedrock exploration system. The system includes transients generated as sudden changes in a transmission stream, which are transmitted into the Earth's subsurface by a transmitter. The induced electric currents thus produced are measured by several receiver units. The measured values from the receiver units are passed to a central unit. The measured values obtained from the receiver units are digitized and stored at the measurement points, and the central unit is linked with the measurement points by a telemetry link. By means of the telemetry link, data from the data stores in the receiver units can be successively passed on to the central unit.

U.S. Pat. No. 5,563,913 issued to Tasci et al. discloses a method and apparatus used in providing resistivity measurement data of a sedimentary subsurface. The data are used for developing and mapping an enhanced anomalous resistivity pattern. The enhanced subsurface resistivity pattern is associated with and an aid for finding oil and/or gas traps at various depths down to a basement of the sedimentary subsurface. The apparatus is disposed on a ground surface and includes an electric generator connected to a transmitter with a length of wire with grounded electrodes. When large amplitude, long period, square waves of current are sent from a transmission site through the transmitter and wire, secondary eddy currents are induced in the subsurface. The eddy currents induce magnetic field changes in the subsurface which can be measured at the surface of the earth with a magnetometer or induction coil. The magnetic field changes are received and recorded as time varying voltages at each sounding site. Information on resistivity variations of the subsurface formations is deduced from the amplitude and shape of the measured magnetic field signals plotted as a function of time after applying appropriate mathematical equations. The sounding sites are arranged in a plot-like manner to ensure that areal contour maps and cross sections of the resistivity variations of the subsurface formations can be prepared.

A limitation to f-CSEM techniques known in the art is that they are typically limited to relatively great water depth, on the order of 800-1,000 meters, or a ratio of ocean water depth to subsurface reservoir depth (reservoir depth measured from the sea floor) of greater than about 1.5 to 2.0.

A typical f-CSEM marine survey can be described as follows. A recording vessel includes cables which connect to electrodes disposed on the sea floor. An electric power source on the vessel charges the electrodes such that a selected magnitude of current flows through the sea floor and into the Earth formations below the sea floor. At a selected distance (“offset”) from the source electrodes, receiver electrodes are disposed on the sea floor and are coupled to a voltage measuring circuit, which may be disposed on the vessel or a different vessel. The voltages imparted into the receiver electrodes are then analyzed to infer the structure and electrical properties of the Earth formations in the subsurface.

Another technique for electromagnetic surveying of subsurface Earth formations known in the art is transient controlled source electromagnetic surveying (t-CSEM). In t-CSEM, electric current is imparted into the Earth at the Earth's surface, in a manner similar to f-CSEM. The electric current may be direct current (DC). At a selected time, the electric current is switched off, and induced voltages and/or magnetic fields are measured, typically with respect to time over a selected time interval, at the Earth's surface. Structure of the subsurface is inferred by the time distribution of the induced voltages and/or magnetic fields. t-CSEM techniques are described, for example, in Strack, K.-M., 1992, Exploration with deep transient electromagnetics, Elsevier, 373 pp. (reprinted 1999).

t-CSEM shows promise as a technique for mapping the Earth's subsurface in relatively shallow marine environments, such as when the water depth is less than about 2 times the depth of a reservoir or other electromagnetically identifiable feature in the Earth's subsurface. What is needed is an improved technique for identification and mapping features in the Earth's subsurface using t-CSEM survey data.

### SUMMARY OF INVENTION

One aspect of the invention is a method for identifying features in the Earth's subsurface below a body of water using transient controlled source electromagnetic measurements. A method according to this aspect of the invention includes acquiring a plurality of transient controlled source electromagnetic measurements. Each measurement represents a different value of an acquisition parameter. Each measurement is indexed with respect to a time at which an electric measuring current source is switched. The plurality of measurements is processed in a seismic trace display format, in which each trace corresponds to the measurement acquired for a value of the acquisition parameter. A subsurface feature is identified from the processed measurements.

Other aspects and advantages of the invention will be apparent from the following description and the appended claims.

### BRIEF DESCRIPTION OF DRAWINGS

FIG. 1 shows a typical data acquisition system and process for marine electromagnetic surveying.

FIG. 2A shows a graph of difference between induced voltages measured for a uniformly conductive Earth having a resistive feature located at various depths below the bottom of a body of water and induced voltages measured where there is no such resistive feature.

FIG. 2B shows a prior art style graphs of induced voltage with respect to time for a reservoir or resistive feature at various depths below the water bottom.

FIG. 3 shows one implementation of a data display and feature identification technique according to the invention.

FIG. 4 shows seismic style data traces representing differences between low resistivity response from FIG. 3 and successively higher resistivity responses from FIG. 3.

FIG. 5 shows a trace set corresponding to various source to receiver offsets.

FIGS. 6A and 6B, respectively, show magnified time scale traces from FIG. 5, and second derivatives of the traces of FIG. 5.

FIGS. 7, 8A and 8B show traces from a simulation similar to that of FIGS. 5, 6A and 6B, and include response of a resistive feature.

FIG. 9A shows apparent resistivity differences between the no-resistive-feature simulation of FIG. 5, for various offsets, and the corresponding simulation, for various offsets, including the resistive feature as shown in FIG. 7.

FIG. 9B shows second derivatives of the difference curves of FIG. 9A.

FIGS. 10A and 10B show, respectively, simulated t-CSEM response in various water depths, without and with a resistive feature.

FIG. 11 shows differences between the no-feature responses of FIG. 10A and the resistive feature responses of FIG. 10B.

FIGS. 12A and 12B show the response, and second derivative thereof, respectively, for various resistivities of a resistive feature in a modeled system including a water layer and a sediment layer.

FIGS. 13A and 13B show, respectively, differences in response between the no-feature response of FIG. 12A, and responses of various resistivities of resistive feature, and the second derivatives thereof.

### DETAILED DESCRIPTION

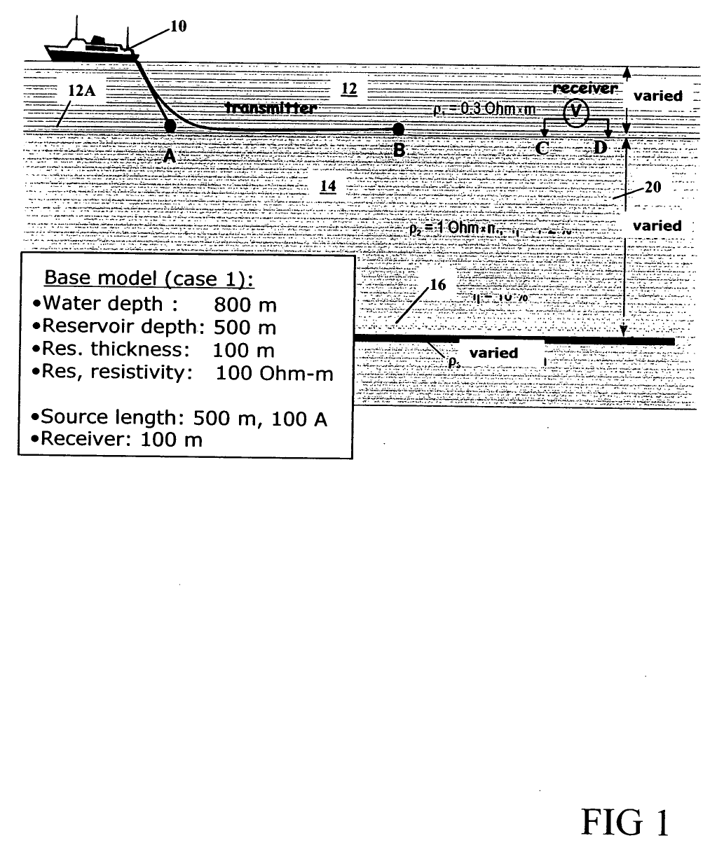

Methods of electromagnetic data display and feature identification were tested by simulating response of a marine transient electromagnetic survey. Referring to FIG. 1, the model simulates a survey vessel 10 which deploys a dipole electric transmitter, shown as electrodes A and B disposed on the bottom 12A of a body of water 12. For purposes of the simulation, the electrode spacing is set at 500 meters. An electric current source (not shown separately) is energized to cause 100 Amperes of current to flow through the electrodes A, B. This is equivalent to typical survey practice known in the art using a 100 meter long transmitter dipole, and using 500 Amperes current. In either case the source moment is 5×10⁴ Ampere-meters. For purposes of the simulation, the current is modeled as direct current (DC) and is switched off at a time index equal to zero. It should be understood, however, that switching the DC off is only one implementation of electric current change that is operable to induce transient electromagnetic effects. In other embodiments, the current may be switched on, may be switched from one polarity to the other (bipolar switching), or may be switched in a pseudo-random binary sequence (PRBS) or any hybrid derivative of such switching sequences. See, for example, Duncan, P. M., Hwang, A., Edwards, R. N., Bailey, R. C., and Garland., G. D., 1980, The development and applications of a wide band electromagnetic sounding system using pseudo-noise source. Geophysics, 45, 1276-1296 for a description of PBRS switching.

An electric dipole receiver includes a time-indexed voltage measuring system 15 (which may be on the vessel 10) coupled to electrodes C and D also on the water bottom 12A. The receiver electrodes C, D are spaced apart at 100 meters. A typical survey technique known in the art uses 10 meter spacing for the receiver dipole electrodes. For purposes of evaluating simulation results the induced voltages should be normalized for the simulated receiver electrode spacing. A source to receiver offset is in an initial model case set to 200 meters. Various offsets up to 3,000 meters and more were used in subsequent simulations of response.

For this model, the electric field transmitted and detected component are referred to as the Eₓ-Eₓ component (inline source, inline receiver), which is believed sufficient for an initial evaluation of the method of this invention.

The modeling technique is described in Edwards, R. N., 1997, On the resource evaluation of marine gas hydrate deposits using the sea-floor transient electric dipole-dipole method, Geophysics, 62, 63-74. The applicability of the foregoing modeling technique was substantiated by reference to Cheesman, S. J., Edwards, R. N., and Chave, A. D., 1987, On the theory of seafloor conductivity mapping using transient EM systems, Geophysics, 52, 204-217. Similar modeling results can be obtained for magnetic field responses using electric and magnetic field transmitters.

The model used represents three discrete layers. First is the body of water 12.

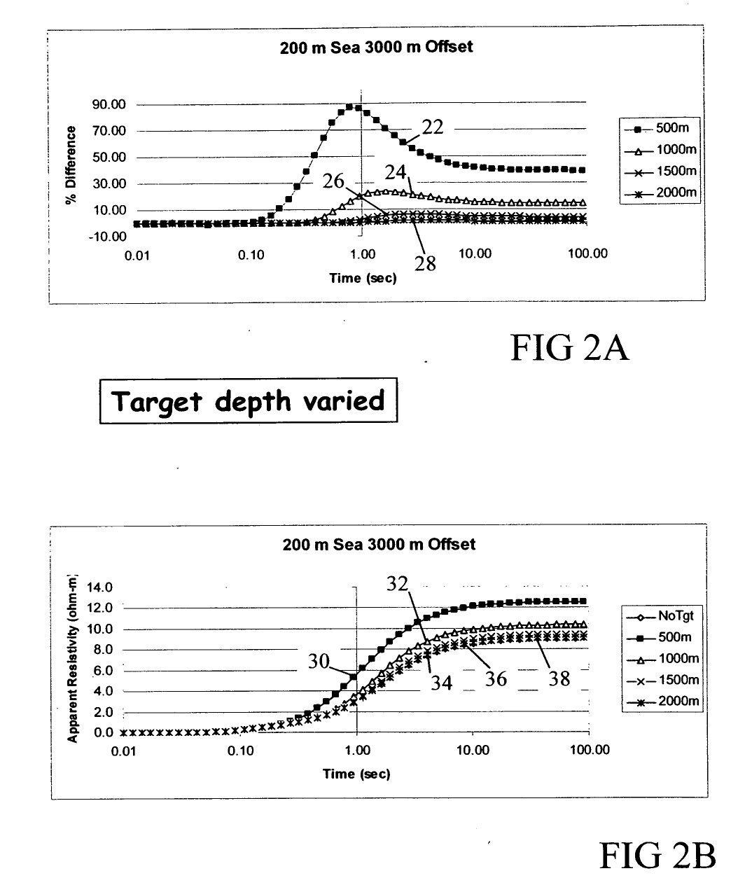

The water 12 is modeled as to have an electrical resistivity of 0.333 Ohm-meters. A resistive feature 16, which has a simulate thickness of 100 meters and a resistivity of 20 Ohm-meters, is located various depths 20 below the water bottom 12A. The resistive feature 16 is overlain by a sediment layer 14 having a resistivity of 1.0 Ohm-meters. In the simulation results, to be described below with reference to FIG. 2, the water depth 18 is set at 200 meters. The resistive feature 16 is intended to include within the simulation a subsurface layer which has electrical properties not unlike a hydrocarbon bearing reservoir. One of the objectives of electromagnetic surveying known in the art is to establish and/or confirm the presence of such subsurface hydrocarbon reservoirs.

A display of simulation results using display techniques known in the art for transient controlled source electromagnetic survey (t-CSEM) data is shown in FIG. 2. The graph in FIG. 2B shows, for a source to receiver offset of 200 meters, and a resistive feature (16 in FIG. 1) having a resistivity of 20 Ohm-meters, the induced voltage with respect to time, on a logarithmic time scale, from the time the electric current is switched off. The curves in FIG. 2B show the expected voltage response for the resistive feature (16 in FIG. 1) for depths below the water bottom of 500 meters (shown by curve 30), 1000 meters (shown by curve 32), 1500 meters (shown by curve 32) and 2000 meters (shown by curve 36). Curve 38 shows the response where there is no resistive feature in the model, meaning that the Earth is represented by a uniform half space of resistivity 1.0 Ohm-meters below the water bottom (12A in FIG. 1)

Differences between the simulated responses for each respective resistive feature depth, and the simulated response with no resistive feature, are shown in FIG. 2A by curves 22, 24, 26 and 28, respectively.

It has been determined that using well known seismic data display techniques, it is possible to identify certain features in the Earth from transient electromagnetic measurements. Generally, in display and identification techniques according to the invention, seismic “wiggle trace” methods (and computer programs therefor) known in the art may be used to display the measurements with respect to time of the current switching, wherein the time scale is linear, and in a visual display of data, typically the area between the trace (curve) and a fixed reference, usually zero trace amplitude, is shaded or blackened for ease of visual interpretation. In a seismic style trace display according to the invention, a plurality of measurements with respect to time (individually called “traces”) may be displayed on the same plot or view, or processed in a particular data set, wherein a parameter related to acquisition and/or processing is different for each successive measurements trace on the multi-trace plot. By displaying the data in this manner, it is possible to identify certain features in the Earth's subsurface more readily than using prior art data display techniques.

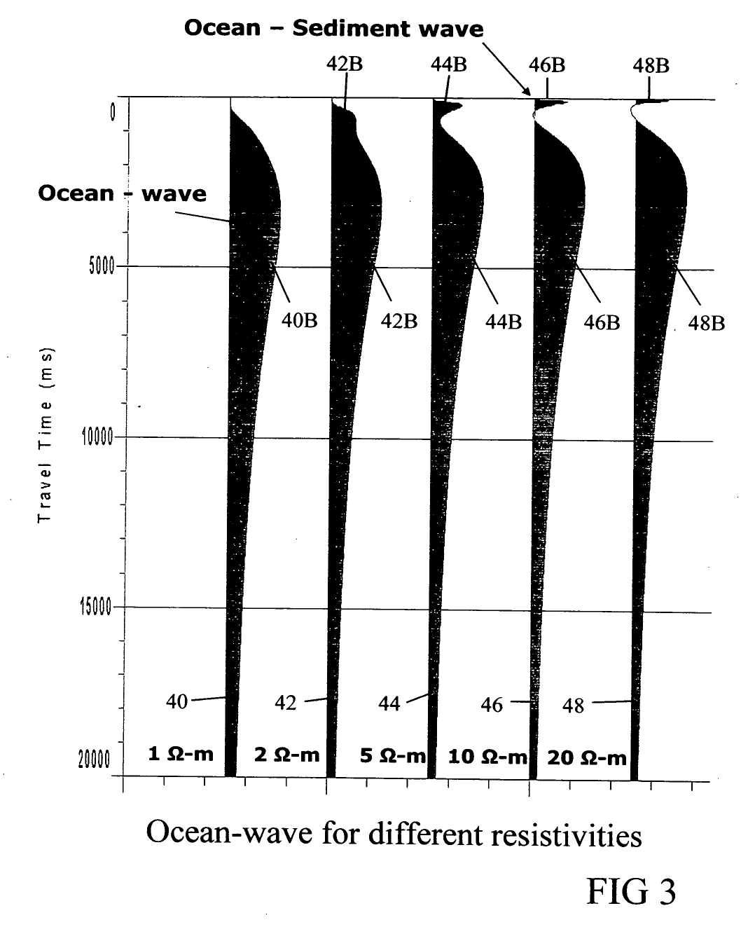

An example of such displays is shown in FIG. 3. Each trace, 40, 42, 44, 46, 48 represents the simulated response of a physical system as shown in FIG. 1, with water layer depth of 800 meters and a water resistivity of 0.333 Ohm-meters. The offset is 3,000 meters and there is no resistive feature (uniform Earth below the water bottom). The sediment resistivity represented by each trace varies from 1.0 ohm-meters (shown by curve 40) to 2 Ohm-meters (shown by curve 42), 5 Ohm-meters (shown by curve 44), 10 Ohm-meters (shown by curve 46) and 20 Ohm-meters (shown by curve 48). The 1 Ohm-meter curve 40 shows only a response called the “ocean wave” 40B, which is essentially the transient electromagnetic response of the water (12 in FIG. 1). As the sediment resistivity is increased, however, a feature becomes visible in each curve, this feature shown at 42A, 44A, 46A, 48A, respectively. The feature corresponds to the sediment electromagnetic response, and it increases in amplitude and becomes shallower in time as the resistivity of the sediment increases.

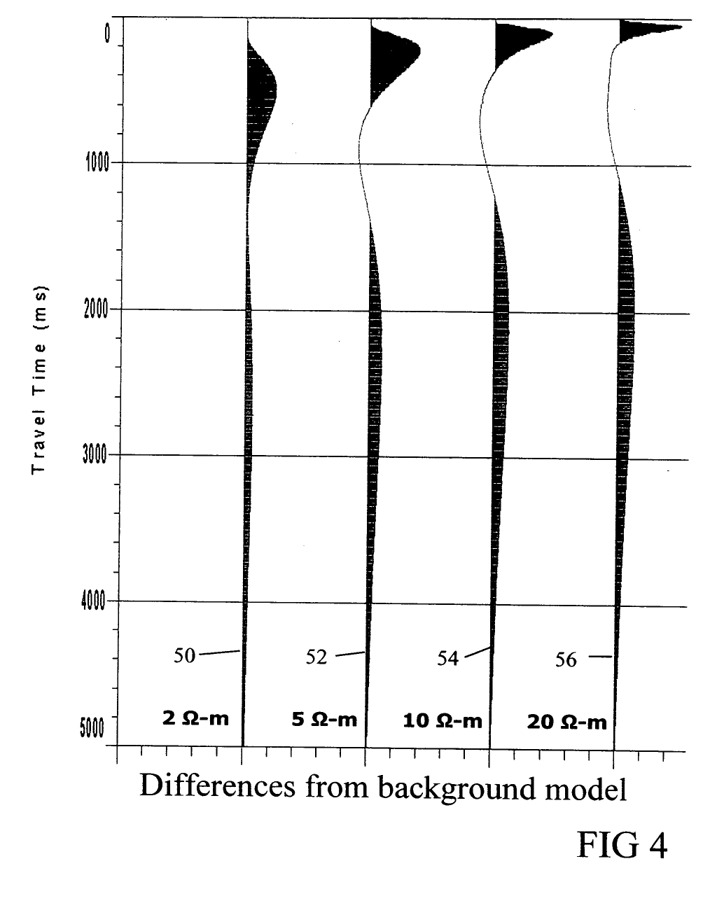

FIG. 4 shows curves 50, 52, 54, 56 representing a difference, respectively, between curves 42 and 40, 44 and 40, 46 and 40 and 48 and 40 in FIG. 3. The difference curves in FIG. 4 essentially null the ocean wave (40B through 48B in FIG. 3) response and magnify the sediment layer response (42A through 48A in FIG. 3). Other data displays, one of which will be discussed in detail below, include having each trace represent the first derivative of the measured value, the second derivative of the measured value, or combinations of derivatives.

In another embodiment, seismic style data displays may be made of the transient electromagnetic response for various offsets in order to identify subsurface features. Where the offset is varied, it is useful to normalize the amplitude response for each offset. In electrical geophysics usually apparent resistivities are used to display the data. Apparent resistivities are curves that give the user an indication of how the resistivity of the subsurface changes, by normalizing the response curve to some selected reference. The generic definition of apparent resistivity is the resistivity of a homogeneous half-space that under the same survey condition yields the measured voltage. Apparent resistivity is used to normalize the voltage response curves and to remove the effects of known geometric parameters, such as source current, source length, receiver length. Offset distance correction allows the user to observe the effect of the relative influences of sediments and sea water in a marine t-CSEM survey. It is similar to the spherical divergence correction in seismic processing. Since the total amplitude of the measured voltage decreases as the cube of the offset (as contrasted with the square of offset, as with a seismic source), plotting voltages instead of apparent resistivity would make the amplitude of a voltage curve for 3,000 meter offset appear 25 times smaller when compared to a 600 meter offset voltage curve. Other normalization factors are possible depending upon physics and display objectives.

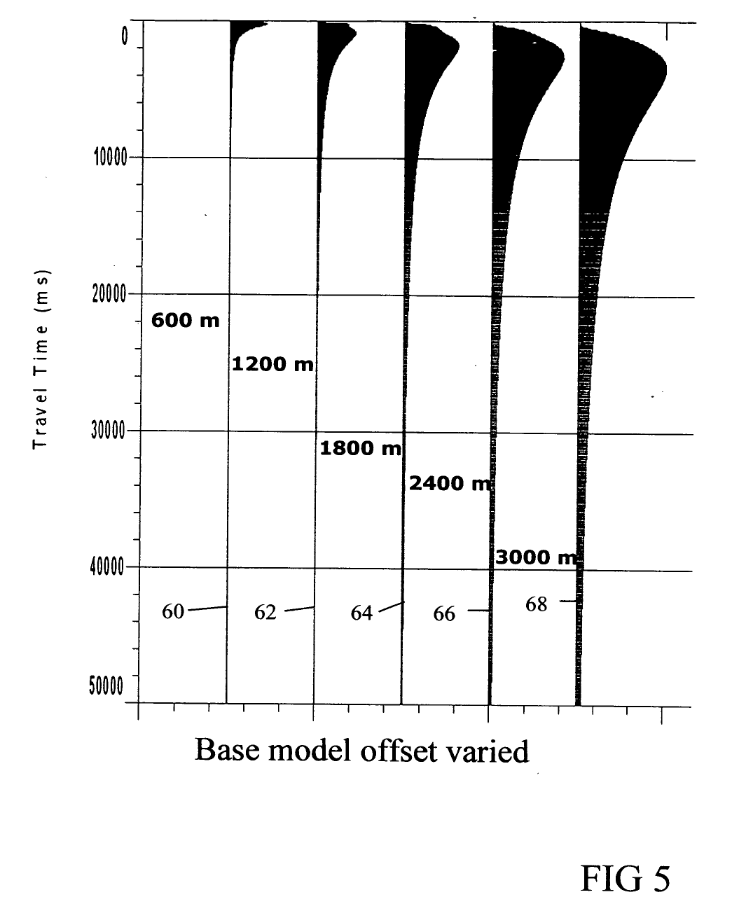

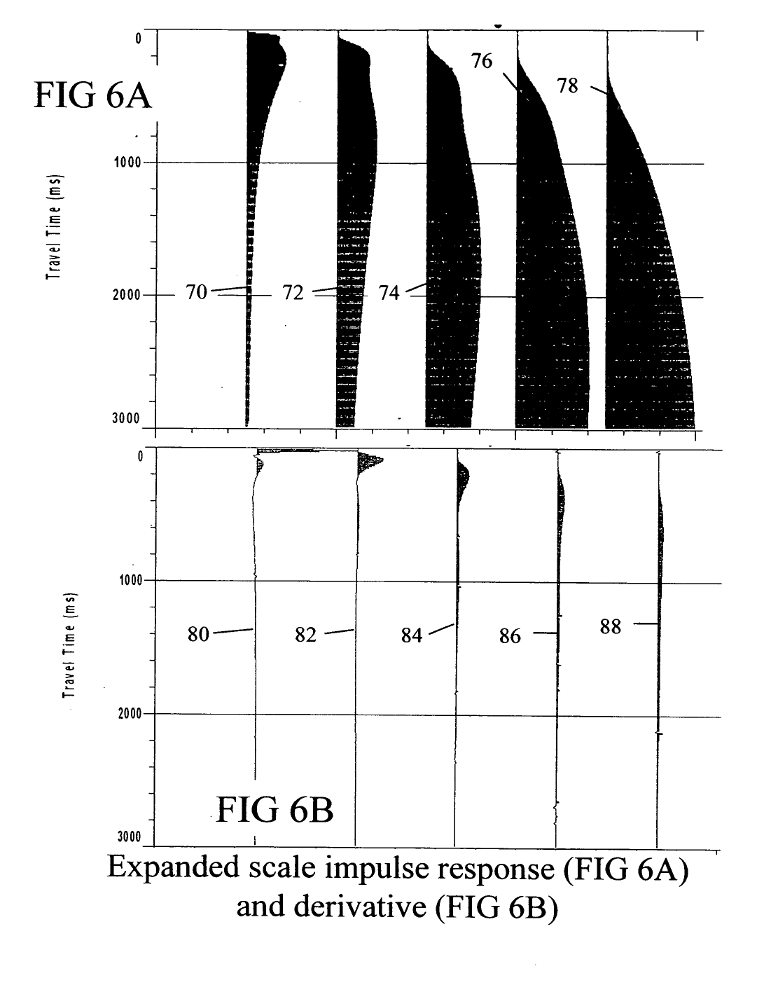

FIG. 5 shows a multiple trace plot of apparent resistivity values for a simulation using an 800 meter deep, 0.333 Ohm-meter resistivity water layer, 1.0 Ohm-meter sediment below the water layer and no resistive feature. Electromagnetic transient response for offsets of 600, 1200, 1800, 2400 and 3000 meters are shown by traces 60, 62, 64, 66, and 68, respectively. FIG. 6A shows the responses of FIG. 5 on a much shorter time scale, at curves 70, 72, 74, 76 and 78 respectively corresponding to curves 60, 62, 64, 66 and 68 in FIG. 5, and the second derivative of the responses, respectively shown by curves 80, 82, 84, 86 and 88 in FIG. 6B.

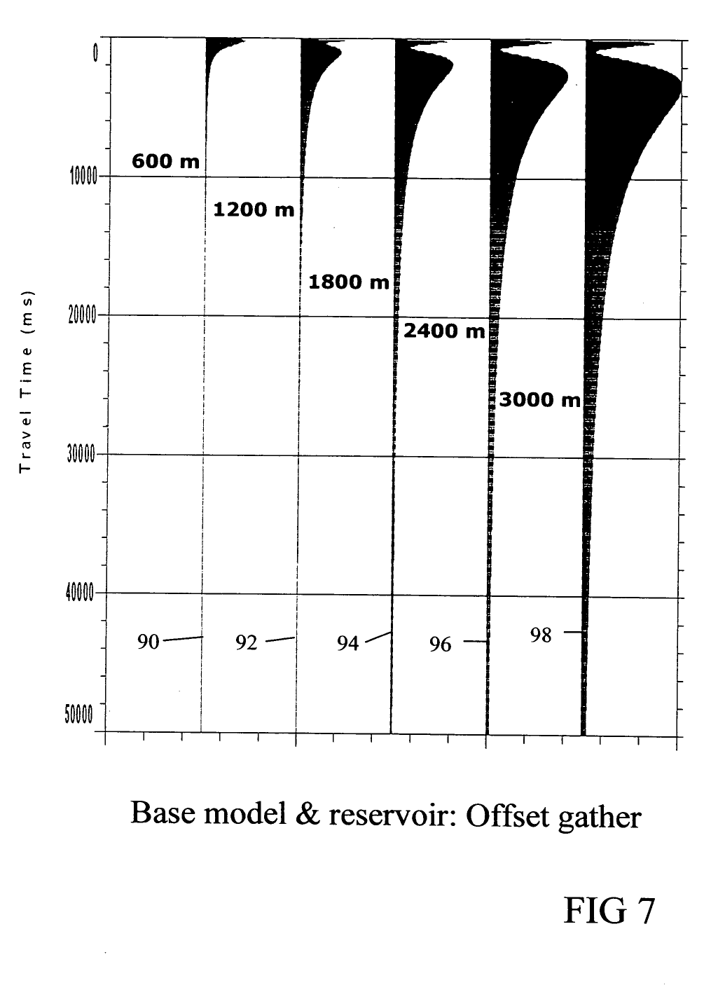

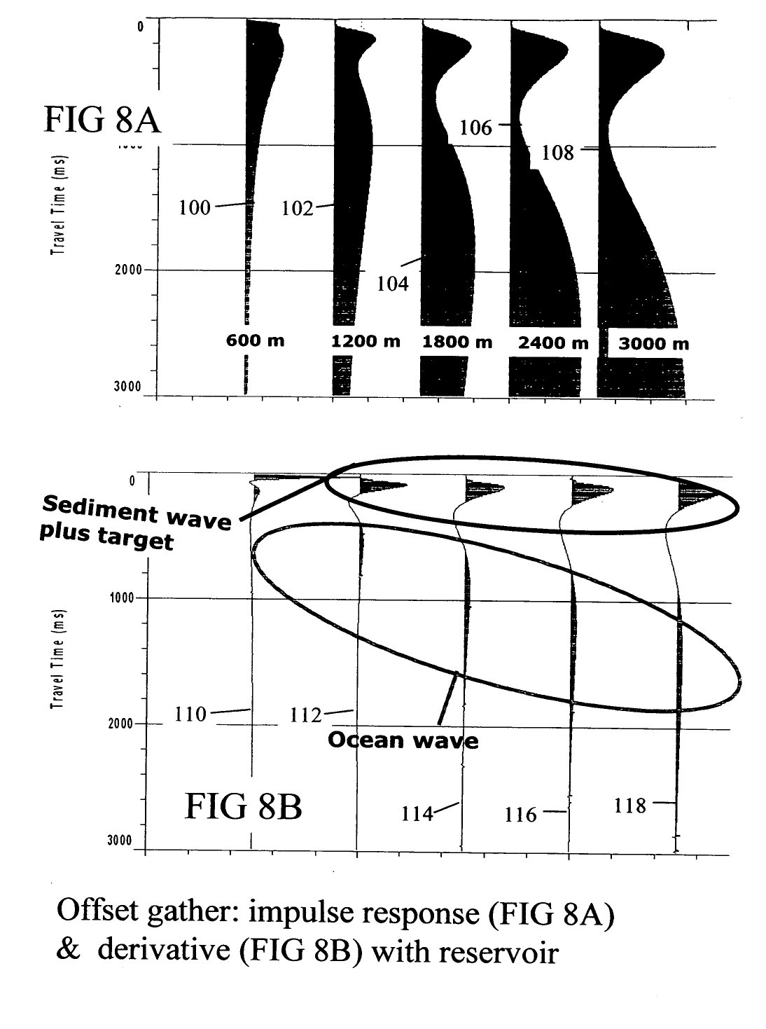

Another simulation includes the same water and sediment layers, and includes a resistive feature, 100 meters thick, 100 Ohm-meters resistivity, and located 500 meters below the water bottom in the sediment layer. Results of the simulation are shown in FIG. 7, which includes traces of the apparent resistivity for various offset values. The offset values are 600 meters (shown by curve 90), 1200 meters (shown by curve 92), 1800 meters (shown by curve 94), 2400 meters (shown by curve 96) and 3000 meters (shown by curve 98). FIG. 8A shows the traces in FIG. 7 on a magnified time scale, at curves 100, 102, 104, 106 and 108m respectively. FIG. 8B shows the second derivatives of the traces of FIG. 8A, respectively at curves 110, 112, 114, 116 and 118. Notably, a distinct resistive feature response is visible at 120 in the second derivative traces of FIG. 8B.

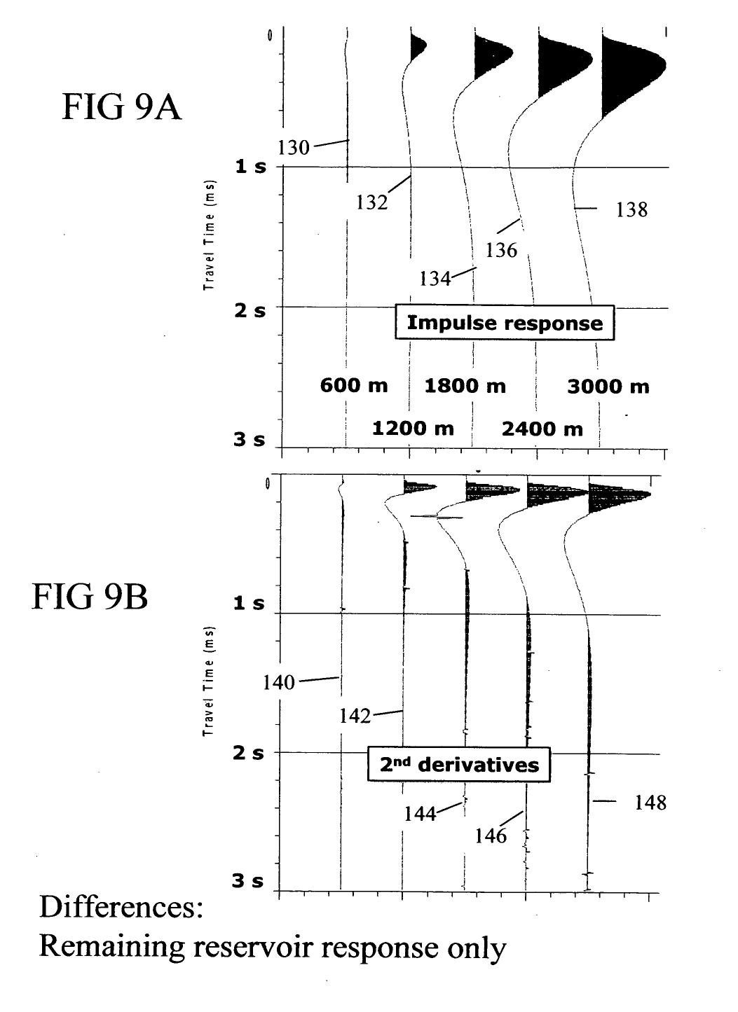

A resistive feature response may be more clearly delineated by calculating differences between response without a resistive feature and response with a resistive feature. Referring to FIG. 9A, each curve represents, for each offset, a difference between the apparent resistivity response of the curves in FIG. 5 and the curves in FIG. 7. The differences are shown at curves 130, 132, 134, 136 and 138, respectively. The response of the resistive feature is clearly visible at 140A in the curves of FIG. 9A. The response of the resistive feature is even more clearly visible in curves shown at 140B in FIG. 9B, which includes a curve representing the second derivative of each curve of FIG. 9A, respectively, curves 140, 142, 144, 146 and 148.

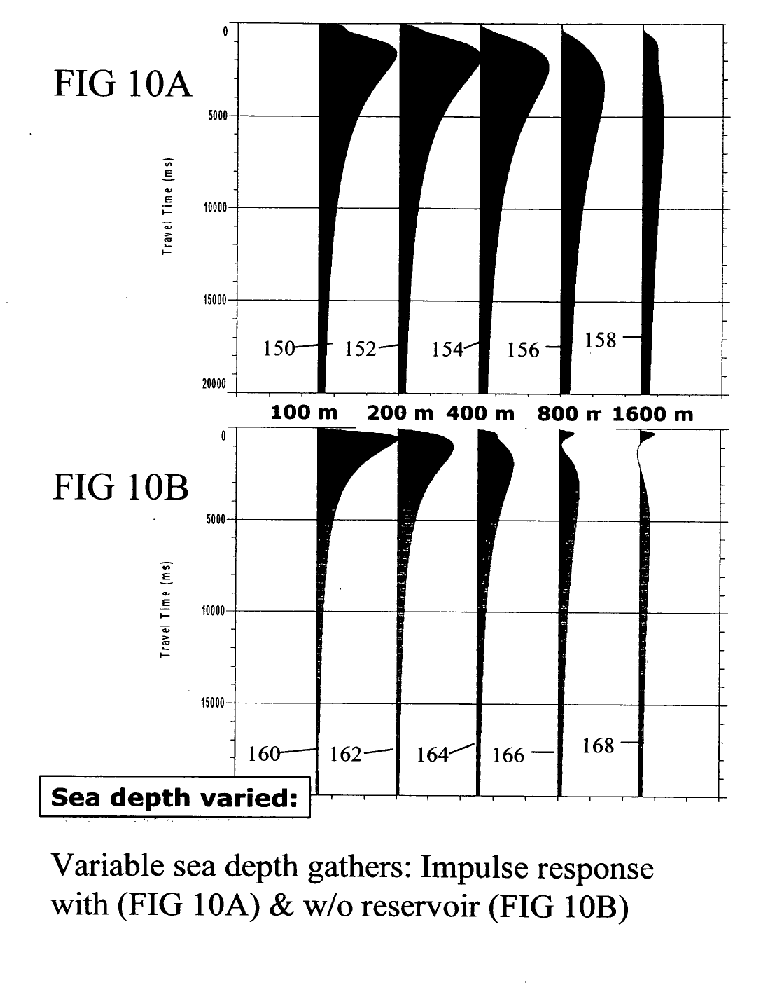

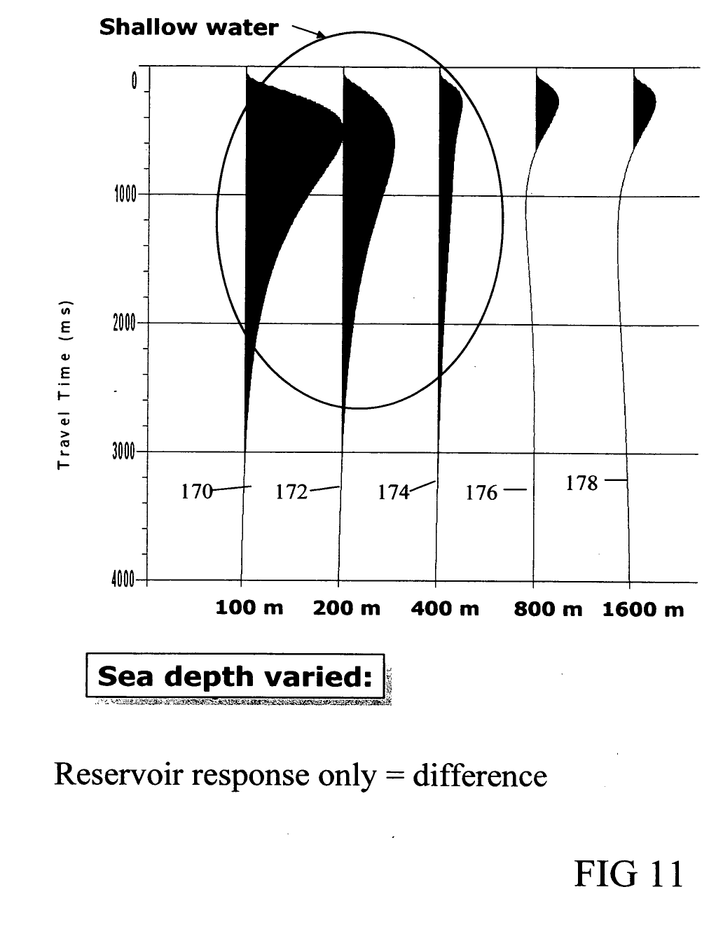

Another parameter that may be varied in each trace of a multiple trace display includes the water depth. Referring to FIG. 10A, a simulation was performed using the same sediment layer (1.0 Ohm-meter half space) below a water layer of 0.333 Ohm-meters. For each response trace in FIG. 10A the water layer depth is indicated for each trace as 100 meters (shown by curve 150), 200 meters (shown by curve 152), 400 meters (shown by curve 154), 800 meters (shown by curve 156) and 1600 meters (shown by curve 158), respectively. A similar set of response curves, simulated using a 100 meter thick, 100 Ohm-meter resistivity feature located 500 meters below the water bottom is shown in FIG. 10B, at curves 160, 162, 164, 166 and 168, respectively. Difference between the respective water depth response curves of FIGS. 10A and 10B are shown in FIG. 11 at curves 170, 172, 174, 176 and 178, respectively. The curves in FIG. 11 primarily show the response arising from the resistive feature, because the sediment and water layer responses largely cancel in the subtraction.

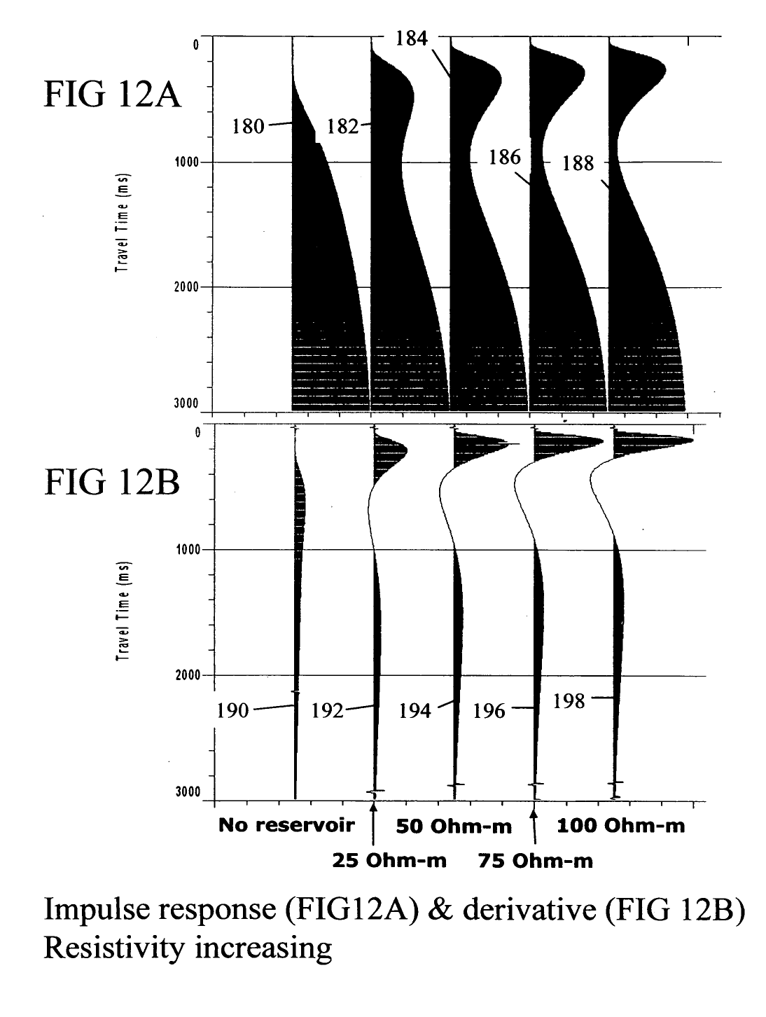

FIG. 12A shows, respectively, the apparent resistivity response curves for a simulation using for no resistive feature (shown by curve 180), and the response curves for resistive features located 500 meters below the water bottom, and for a feature resistivity of 25 Ohm-meters (shown by curve 182), 50 Ohm-meters (shown by curve 184), 75 Ohm-meters (shown by curve 186) and 100 Ohm-meters resistive features.

FIG. 12B shows second derivatives of the curves in FIG. 12A, at curves 190, 192, 194, 196 and 198, respectively. The effect of change in resistivity of the resistive feature can be clearly seen at 190A in FIG. 12B.

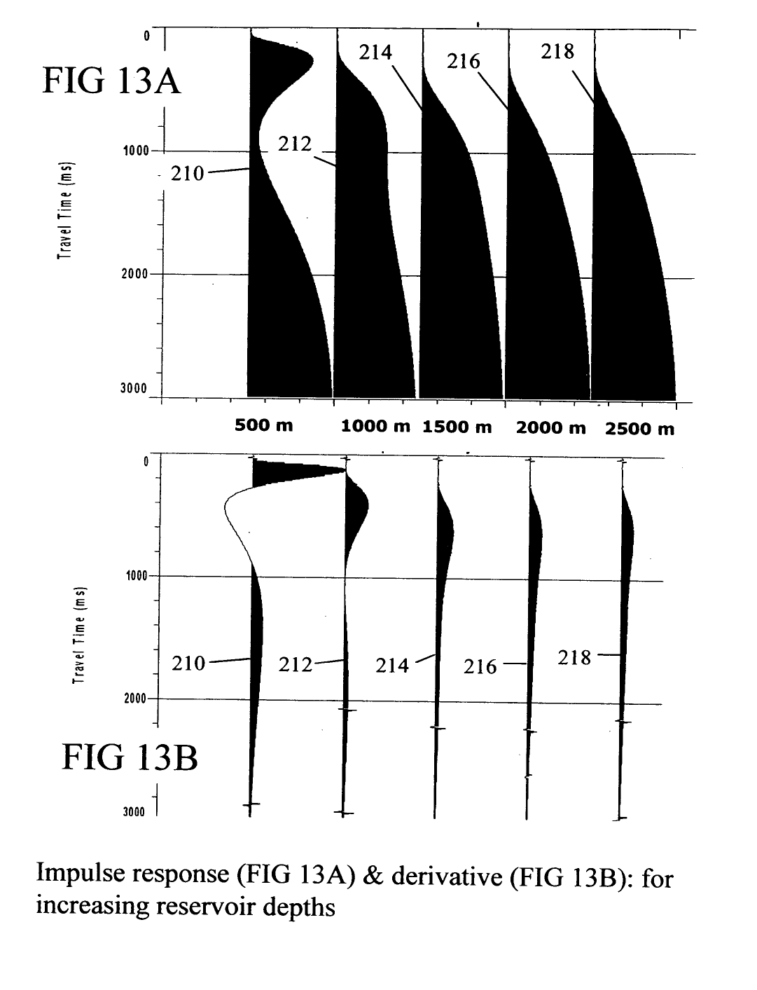

FIG. 13A shows apparent resistivity response for a 100 Ohm-meter resistive layer located at depths of 500 meters (shown by curve 200), 1000 meters (shown by curve 202), 1500 meters (shown by curve 204), 2000 meters (shown by curve 206) and 2,500 meters (shown by curve 208) below the water bottom in the sediment layer, respectively. Second derivative curves corresponding to each apparent resistivity curve are shown in FIG. 13B at curves 210, 212, 214, 216 and 218, respectively. The apparent response of the resistive feature is decreased in amplitude and spread in time as the resistive feature is moved deeper into the sediment layer.

The foregoing examples of simulated marine transient electromagnetic survey are provided to explain the general concept of the invention, which is to present t-CSEM data in a seismic trace format, such that each data trace corresponds to a particular value of an acquisition parameter. In all the foregoing examples, the simulated data correspond to a transient electric field being imparted into the Earth's subsurface, and measurements being made of the induced electric field in the Earth's subsurface. It should be clearly understood, however, that the principles of the invention are also applicable to combinations of transient electric and magnetic fields, and measurements made therefrom. For example, a transient electric field, induced using a system as shown in FIG. 1, may have, in addition to or in substitution thereof, measurements made of the induced magnetic field, using magnetic field sensors placed at selected locations along the sea floor. The magnetic field measurements may be made in directions along and/or orthogonal to the direction of the induced electric field. See U.S. Patent No. U.S. Pat. No. 5,467,018 issued to Rueter et al. Conversely, a magnetic field may be induced in the Earth's subsurface by passing electric current through a wire loop. See, for example, Strack, K.-M., 1992, Exploration with deep transient electromagnetics, Elsevier, 373 pp. (reprinted 1999). Induced electric and/or magnetic fields may then be measured, and displayed according to any of the foregoing aspects of the invention in order to infer the subsurface structure and electrical properties of the Earth formations.

All of the foregoing examples of marine transient electromagnetic survey processing and display techniques used time as the basis for processing and indexing of the processed data. It is possible to convert the time indexed processing to depth indexed processing by using electrical resistivity data from a wellbore penetrating the Earth's subsurface in the vicinity of the transient electromagnetic survey. The resistivity data may be obtained by lowering in instrument into the wellbore on the end of an armored electrical cable. The instrument may make measurements of electromagnetic induction properties and/or galvanic properties of the Earth formations surrounding the wellbore. A record of the measurements is typically made with respect to depth in the Earth of the instrument. The electrical properties with respect to depth may be used to convert the time indexed transient electromagnetic measurements to measurements indexed with respect to depth. See, for example, U.S. Pat. No. 5,883,515 issued to Strack et al., which discloses a method of determining selected parameters of an earth formation surrounding a borehole. The method disclosed includes first, obtaining at least one induction logging measurement of the selected parameters in a first predetermined volume of the formation surrounding the borehole having known first radial and vertical dimensions, then obtaining at least one galvanic logging measurement of the identical selected parameters in a second predetermined volume of the formation surrounding the borehole having known second radial and vertical dimensions that overlap the first radial and vertical dimensions of the first predetermined volume, whereby the overlapping volumes form a representative common volume of the formation, and then combining the induction and galvanic logging measurements using an inversion technique to obtain a measurement of the selected parameters of the earth formation surrounding the borehole in the representative common volume of the formation.

In some embodiments, the parameter that is varied between individual traces maybe determined by sensitivity analysis. Sensitivity analysis may be performed by using the forward modeling procedure explained above with reference to FIGS. 1 through 13B to obtain estimated responses of the particular survey system used to a model of the subsurface Earth formations below a water layer of selected depth and resistivity (both the foregoing may be taken directly from the actual survey procedure). The parameters such as offset, resistive feature thickness, resistive feature depth and sediment layer resistivity may be used to determine the parameter that provides the most change in the simulated transient response, or most clearly delineates features in the subsurface.

From the foregoing examples of voltage response trace presentation and apparent resistivity presentation, and differences and second derivatives thereof, it is believed that t-CSEM measurements may be processed using well known seismic processing techniques to infer the presence of and electrical properties of various features below the bottom of a body of water. Such processing, display and analysis may make possible inference of certain features and properties that were not possible using data display and analysis techniques known in the art for processing t-CSEM measurement data. Finally, it is believed that data processing and display techniques according to the invention may make possible interpretation of CSEM surveys made where the water depth is less than about 1.5 to 2.0 times the depth to various target formations or resistive features in the Earth's subsurface.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for identifying features in the Earth's subsurface below the bottom of a body of water using transient controlled source electromagnetic induction voltage measurements, comprising:
acquiring a plurality of transient controlled source electromagnetic measurements, each measurement corresponding to a different value of an acquisition parameter, each measurement indexed with respect to a time at which an electric measuring current source is switched;
processing the plurality of measurements in a seismic trace format, wherein each trace corresponds to the measurement acquired for a different value of the parameter; and
identifying a subsurface feature from the processed measurements.

2. The method of claim 1 further comprising:
determining at least one of a difference to a reference, a first derivative, a second derivative and a combination of derivatives with respect to time of selected ones of the measurements;
processing the determined at least one of a difference, first derivative, second derivative and combination of derivatives in the seismic trace display format, each trace corresponding to a value of the parameter; and
identifying a subsurface feature from the processed at least one of a difference, first derivative, second derivative and combination of derivatives.

3. The method of claim 1 wherein the parameter comprises offset distance between current source electrodes and voltage measurement electrodes.

4. The method of claim 3 further comprising calculating an apparent resistivity for each measurement, and displaying the apparent resistivity values in substitution of the measurement values in the seismic trade display format.

5. The method of claim 3 further comprising normalizing an amplitude of each measurement in relation to an offset thereof.

6. The method of claim 1 wherein the measurements comprise voltage corresponding to an electric field amplitude.

7. The method of claim 1 wherein the measurements comprise magnetic field amplitude.

8. The method of claim 1 wherein the measurements comprise induced voltage corresponding to a magnetic field amplitude

9. The method of claim 1 wherein the acquiring comprises inducing transient electric fields in the Earth's subsurface.

10. The method of claim 1 wherein the acquiring comprises inducing transient magnetic fields in the Earth's subsurface.

11. The method of claim 1 wherein the parameter is selected by performing a sensitivity analysis.

12. The method of claim 1 wherein a ratio of depth of the water layer to depth below the bottom of the water layer of the subsurface feature is less than about 1.5.

13. The method of claim 1 further comprising measuring a property corresponding to electrical resistivity from a wellbore drilled through the subsurface, the measuring performed with respect to depth, and calibrating the controlled source transient electromagnetic measurements with respect to the depth based on the measured property corresponding to resistivity.

14. A method for evaluating features in the Earth's subsurface below the bottom of a body of water, comprising:
applying at least one of a controlled source, transient magnetic field and a controlled source, transient electric field to formations from a position proximate the bottom of the body of water;
detecting at least one of an electric field amplitude and a magnetic field amplitude from a position proximate the bottom of the body of water, the detecting referenced with respect to a time at which a current source used to apply the at least one of an electric and magnetic fields is switched; and
inferring the presence of a feature in the subsurface from the measurements of the at least one of the electric field and the magnetic field, wherein the measuring and detecting is performed such that a ratio of the depth of the body of water to a depth within the subsurface below the water bottom of the feature is less than about 1.5.

15. The method of claim 14, further comprising:
applying the at least one electric and magnetic field a plurality of times;
acquiring a plurality of measurements of the at least one electric and magnetic fields, each acquisition having a different value of a parameter related to the acquisition;
processing the plurality of measurements in a seismic trace format, wherein each trace corresponds to the measurement acquired for a different value of the parameter; and
identifying the subsurface feature from the processed measurements.

16. The method of claim 15 wherein the parameter comprises offset distance between current source electrodes and voltage measurement electrodes.

17. The method of claim 16 further comprising calculating an apparent resistivity for each measurement, and displaying the apparent resistivity values in substitution of the measurement values in the seismic trade display format.

18. The method of claim 16 further comprising normalizing an amplitude of each measurement in relation to an offset thereof.

19. The method of claim 15 wherein the measurements comprise voltage corresponding to the electric field amplitude.

20. The method of claim 15 wherein the measurements comprise the magnetic field amplitude.

21. The method of claim 1 wherein the measurements comprise induced voltage corresponding to the magnetic field amplitude.
